(19) United States
(12) Patent Application Publication
(10) Pub. No.: US 2004/0066404 A1
(43) Pub. Date: Apr. 8, 2004

(54) Adding contacts to recipient list

(75) Inventors: Dale W. Malik, Dunwoody, GA (US); Mary S. Arnoff, Lawrenceville, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BellSouth Intellectual Property Corporation, Wilmington, DE (US)

(21) Appl. No.: 10/324,779

(22) Filed: Dec. 19, 2002

Related U.S. Application Data
(60) Provisional application No. 60/416,916, filed on Oct. 8, 2002.
(60) Provisional application No. 60/426,146, filed on Nov. 14, 2002.

(51) Int. Cl. G09G 5/00

(52) U.S. Cl. 345/752; 345/783

(57) ABSTRACT

A user friendly e-mail client is provided. A representative e-mail client includes a mailbox representation of a mailbox and an address book representation of an address book. The mailbox is operable to enable a user to review summary information regarding received messages. The address book representation is operable directly from the mailbox representation to enable the user to select recipients for an outgoing message. The address book representation is further operable to enable the user to enter a new addressee and addressee contact information comprising a contact directly into the address book. Methods and computer readable media for e-mail clients are also provided.

### CROSS-REFERENCE TO RELATED APPLICATIONS

This application claims priority to and incorporates by reference both copending U.S. provisional application entitled, “FUNCTIONAL SPECIFICATION FOR E-MAIL CLIENT,” having Ser. No. 60/416,916, filed Oct. 8, 2002, and U.S. provisional application entitled “ADDING CONTACTS TO RECIPIENT LIST,” having Ser. No. 60/426,146, filed Nov. 14, 2002.

### FIELD OF THE INVENTION

The present invention relates generally to communications software, and more particularly to e-mail client software.

### DESCRIPTION OF THE RELATED ART

The development of the internet has driven vast technological developments, particularly in the areas of networking hardware and software. Networking hardware developments have enabled networks to transfer large files in fractions of a second. Software developments, such as the world-wide-web (web) and e-mail, have facilitated communications over these networks that have enabled users to remain in almost constant contact with each other.

Typically, e-mail clients (e.g. workstation e-mail applications) were created for sophisticated business users. However, a significant number of e-mail users have little prior experience with computers. These inexperienced users have some trouble using present e-mail clients. In Microsoft Outlook, available from Microsoft Corp. of Redmond, Wash., many of the functions are not very intuitive. For example, the processes of adding contacts and creating new mailing lists can occur in a somewhat convoluted manner. Such types of problems may inhibit some users from efficiently using e-mail clients. Moreover, the problems effectively remove much of the power of the client, since a feature that is difficult to use is only marginally better than no feature at all. Even worse, some users may be so disenchanted by their difficulties with using an e-mail client with a poorly designed user interface, that they will stop using the internet service altogether.

Therefore, there is a need for systems and method that address these and/or other perceived shortcomings of the prior art.

### SUMMARY OF THE INVENTION

One embodiment, among others, of the present invention provides an e-mail client that includes a mailbox and an address book, i.e., software provides functionality to display and enable interaction with mailbox and address book representations. The mailbox representation enables a user to review summary information regarding received messages and readily view and access the address book. The address book representation enables the user to choose the recipients of an outgoing message by selecting contacts from a previously stored list of addressees, and further enables the user to enter a new addressee and contact information for the addressee directly into the address book.

Another aspect, among others, of one embodiment of the present invention provides a computer readable medium having a program to provide an address book comprising a plurality of contacts. The program includes the steps of: displaying an address book representation of an address book to a user, the address book representation comprising a list of contacts included in the address book; enabling the user to select a plurality of contacts from the address book representation; and, creating a recipient list comprising the plurality of selected contacts upon completion of selection by the user.

Other systems, methods, features, and advantages of the present invention will be or become apparent to one with skill in the art upon examination of the following drawings and detailed description. It is intended that all such additional systems, methods, features, and advantages included within this description and be within the scope of the present invention.

### BRIEF DESCRIPTION OF THE FIGURES

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram illustrating an embodiment, among others, of an architecture used to transfer e-mail between client computers.

FIG. 2 is a block diagram of an embodiment, among others, of an architecture of the client computer of FIG. 1 which can include the e-mail client of the present invention.

FIG. 3 is a sample screen shot of an embodiment, among others, illustrating the main window of the e-mail client of FIG. 2.

FIG. 4 is a sample screen shot of an embodiment, among others, of a message composition window of the e-mail client of FIG. 2.

FIG. 5 is a sample screen shot of an embodiment, among others, of an address book of the present invention included in the e-mail client of FIG. 2.

FIG. 6 is a sample screen shot of an embodiment, among others, of an add contact window of the present invention included in the e-mail client of FIG. 2.

FIG. 7 is a flowchart illustrating an embodiment, among others, of a method illustrating the flow of an address book portion of the e-mail client of FIG. 2.

### DETAILED DESCRIPTION OF THE PREFERRED EMBODIMENTS

The preferred embodiments of the present invention now will be described more fully with reference to the accompanying drawings. The invention may, however, be embodied in many different forms and should not be construed as limited to the embodiments set forth herein; rather, these embodiments are intended to convey the scope of the invention to those skilled in the art. Furthermore, all “examples” given herein are intended to be non-limiting.

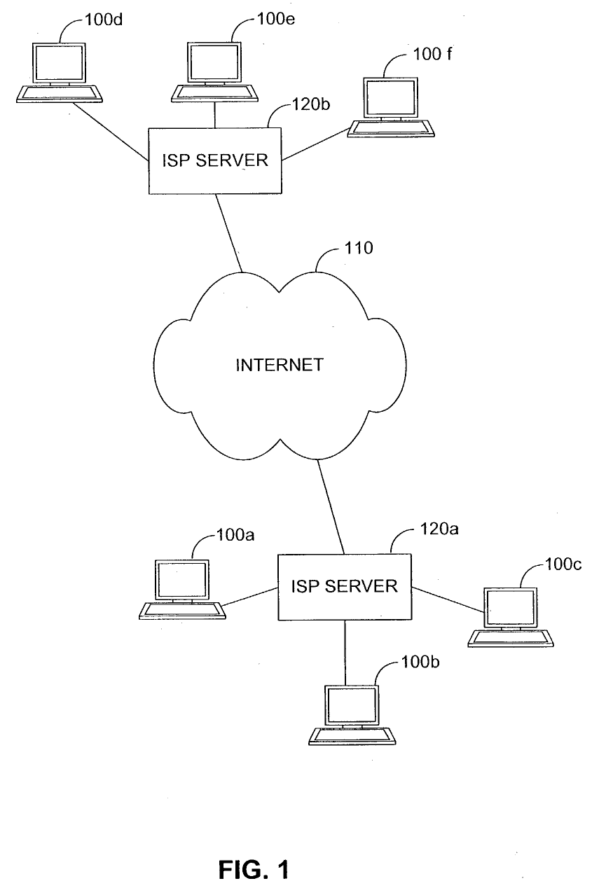

Referring now to FIG. 1, shown is a block diagram illustrating an architecture, used for e-mail transport and delivery used in one embodiment, among others, of the present invention. Each of a plurality of remote computers 100a-f access the internet 110 (or other network) through a local internet service provider (ISP) server 120a, 120b (or other gateway systems). It should be recognized by one skilled in the art that the ISP server 120a, 120b can offer access to the internet 110 through a myriad of connection types, including a digital subscriber line (DSL) service, an integrated services digital network (ISDN) service, an analog dial-up service, ethernet, T-1, or any other service for transmitting data through a network. Each of the ISP servers 120a, 120b, in turn, are connected to the internet 110. This internet connectivity enables the ISP servers 120a, 120b and other servers connected to the internet to transfer information amongst the servers 120a, 120b using various universal protocols recognized by the servers.

With specific regard to e-mail, the ISP servers 120a, 120b generally include both a post office protocol 3 (POP3) server and a simple mail transfer protocol (SMTP) server with a multipurpose internet mail extension (MIME). Typically, the e-mail client on computers 100a-f include a POP3 component and an SMTP component with MIME encapsulation for non-ascii attachments. The SMTP component on a computer 110a-c will transfer an e-mail message in the SMTP format to the SMTP server residing on an ISP server 120a. The SMTP server then transfers it to the correct ISP server 120b where it is stored on the POP3 server. Alternatively, one skilled in the art should recognize that the POP3 server can be replaced by an internet message access protocol 4 (IMAP4) server which can perform all of the POP3 functions and features additional functions for flexibility and efficiency. As mentioned before, the computers 100a-f each have an e-mail client that includes a POP3 component. The POP3 component on the computer 100d-f can contact the POP3 server on the local ISP server 120b and retrieve messages for the user logged in to the client on the respective computer 100d-f.

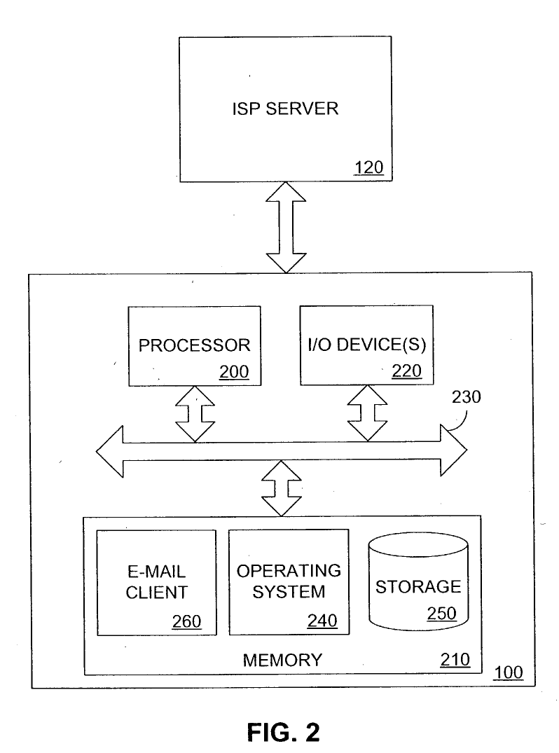

Referring now to FIG. 2, shown is block diagram of an embodiment of a computer system in accordance with the present invention. As known to those skilled in the art, a computer system typically includes a processor 200, memory 210 and input/output (I/O) device(s) 220, all communicating over a bus 230. The memory typically includes the operating system 240 and non-volatile storage 250. The operating system is typically stored in non-volatile memory while the computer 100 is turned off, and loaded into volatile memory upon start-up, where it can be executed by the processor 200. In the present embodiment, the memory includes an e-mail client 260 which enables the computer to send/receive e-mail messages to/from the ISP server 120 through an I/O device 220 such as an analog modem, DSL modem, ISDN modem or ethernet card, among others. The e-mail client 260, as discussed above, typically includes a receive component (such as POP3) to receive e-mail, a transfer component (such as SMTP) to send e-mail, and some sort of user interface logic to format the output to provide a display that can be understood by the computer user.

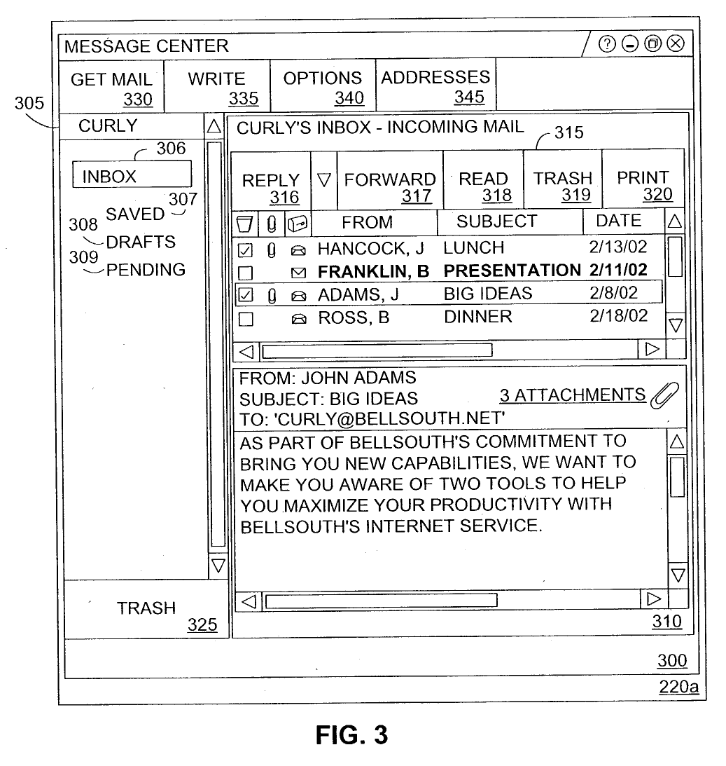

Referring now to FIG. 3, shown is a sample screen shot of an embodiment, among others, for a mailbox window associated with the e-mail client of FIG. 2. The message center representation 300 is typically displayed on a I/O display device 220a, such as a conventional computer display, for example. The message center representation 300 in this embodiment, among others, includes three sections: a mailbox representation portion 305, an active mailbox folder pane 310, and a trash folder designation 325. The mailbox representation portion 305 typically is located to the left side of the message center and includes the mailbox folder designations 306, 307, 308, 309 that can be selected by the user.

When the user selects a mailbox folder designation 306, 307, 308, 309, message header designation (summary information) for messages stored in that associated mailbox folder appear in an active mailbox folder pane 310. A typical display for the active mailbox folder pane is shown in FIG. 3, however, one skilled in the art will understand that many different configurations exist for viewing content representations for various mailbox folders, and each of these configurations are intended to be included within the scope of the present invention. When a user selects a message header designation from the top portion of the active mailbox folder pane 310, the message can preferably be previewed in the lower portion of the active mailbox folder pane 310. Moreover, the active mailbox folder pane 310 can include a plurality of user-selectable buttons 315 at the top of the pane 310 for instructing the e-mail client how to treat the highlighted message. Typical treatments for incoming e-mail are “Reply,” “Forward,” “Read,” “Trash,” and “Print.” One skilled in the art will recognize basic aspects of each of these functions from other e-mail clients. The “Reply” button 316 and “Forward” button 317 typically open a “Write” window, where messages can be composed by the user with some of the fields filled in according to the function requested and the preferences of the user. The “Read” button 318 typically opens a review window, where the user can review the highlighted message. The “Trash” button 319 typically moves the highlighted message to the “Trash” folder designation 325, and the “Print” button 320 sends the highlighted message to an I/O printer device (not shown) for printing.

The message center representation 300 further includes a plurality of user-selectable buttons 330, 335, 340, 345 which control various functions performed by the e-mail client. The “Get Mail” button 330, when selected, forces the e-mail client to retrieve mail from a specified e-mail server. The “Write” button enables the user to open a “Write” window, where messages can be composed by the user. The “Options” button 340 enables the user to open a window to set up options with regard to user preferences, e-mail accounts, etc. The “Addresses” button 345 enables the user to open a window to view an address book representation of address book data entered into the e-mail client by the user. The address book representation and address book data will be discussed in more detail below after discussion of other ways in which the address book representation can be accessed.

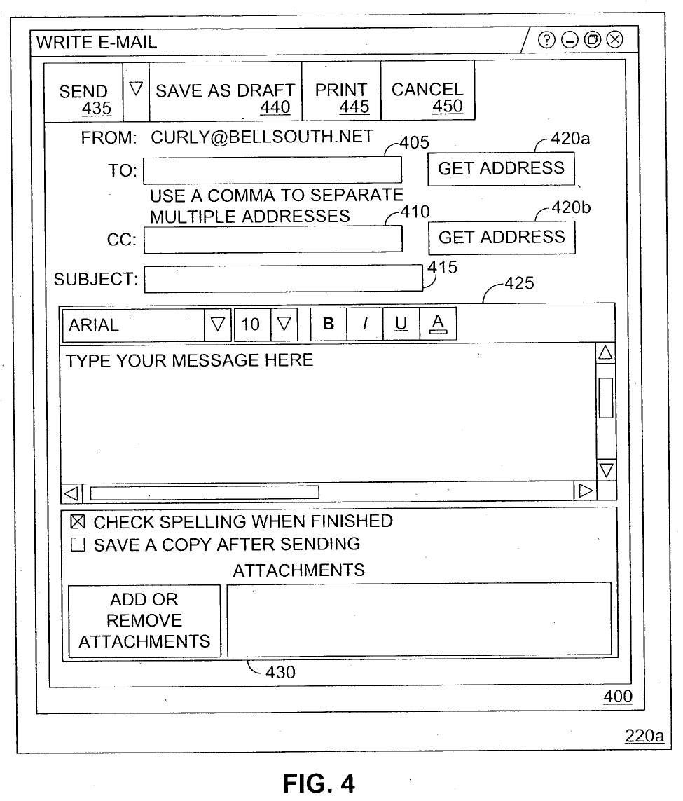

Referring now to FIG. 4, shown is a typical embodiment, among others, of a “Write” window 400. The “Write” window 400 will typically appear on the I/O display device 220a after the user has selected the “Write” button 335 (FIG. 3), the “Reply” button 316 (FIG. 3), or the “Forward” button 317 (FIG. 3). Typically the fields of the “Write” window 400 will be unpopulated prior to the user entering information into the fields. However, in the case of viewing the “Write” window 400 after selecting the “Reply” button 316 or “Forward” button 317 some of the fields may appear pre-populated with information from the message that was highlighted prior to selecting the buttons 316, 317. The “To:” field 405 tells the user who the message will be sent to. This “To:” field 405 is typically filled in when the user selects the “Reply” button 316 (FIG. 3) from the message center window 300. The “Cc:” field 410 includes those users to whom the message will be sent as a “carbon copy,” meaning that the same message will be sent to those recipients in the “Cc:” field 410, even though it is not directly addressed to them. Together the “To:” field 405 and the “Cc:” field 410 comprise a recipient list for the e-mail. The user can further enter a subject to the message, which will typically appear in the header of the message upon receipt by the users on the recipient list. Further, the “Write” window 400 will enable the user to access an address book window (representation) through the “Write” window 400 through the “Get Address” buttons 420a, 420b. In the address book window, the user will be enabled to select the recipients for inclusion into the “To:” and “Cc:” fields 405, 410.

The user is typically allowed to write a message in field 425. There is typically no limit on the length of messages sent, however, some mail systems limit the size of messages received by a user. Furthermore, the user can generally “attach” a non-ascii document to an e-mail by using the attachment window 430. Upon completion of the message the user can send the message by selecting the “Send” button 435. Alternatively, in some embodiments, among others, the user can choose the “Save as Draft” button 440 which will save the message in a drafts folder 308 (FIG. 3), print the message by selecting the “Print” button 445, or cancel the message by clicking the “Cancel” button 450. One skilled in the art will recognize that there are many different formats for attaching documents and enabling users to compose messages, and that each of these formats are intended to be included within the scope of the present invention.

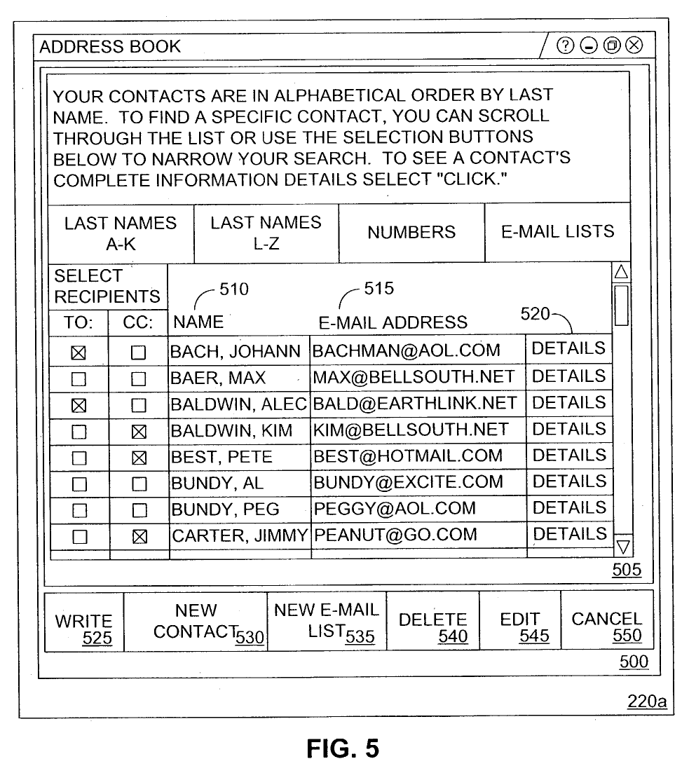

Referring now to FIG. 5, shown is an address book window 500 of one embodiment, among others, that will appear upon selecting one of the “Get Address” buttons 420a, 420b in the “Write” window 400 of FIG. 4. Typically, the address book window 500 will contain a list of contact designations 510 that are associated with e-mail addresses that can be added to a recipient list. In other e-mail systems, such as Outlook, an address book and a contact list are separate entities, and unsophisticated users can have a difficult time figuring out why addresses that they have entered in their contacts do not appear in the address book representation, and why the e-mail addresses they have entered in the address book do not appear as contact designations. In one embodiment, among others, of the present invention, the differences between any contact list and the address book are eliminated. Moreover, creating mailing lists for users can be made easier by enabling the user to select to save the list and name it for re-use. The address book data is typically stored on the client computer, however in one embodiment, address book data can be stored at a server location and downloaded to the client computer upon request. In that embodiment, edits to the data are relayed to the server to maintain synchronization between client and server.

As can be seen with reference to FIG. 5, the address book window 500 preferably can be accessed by clicking the “Get Address” button 450 of FIG. 4, or by merely selecting the “Addresses” button 345 of FIG. 3. For example, each of various contact designations 510 is associated with (linked to) an e-mail address 515 that can be used to send e-mail messages to that addressee. The user can view the details of any of the contacts by clicking a “Details” button 520 to the right of the contact designation 510 that the user wishes to view. By checking a “To:” or “Cc:” box to the left of a particular contact designation 510, the user is selecting to add (the associated e-mail address of) that contact designation 510 to the recipient list.

After checking all of the contact designations 510 that the user wishes to check, and unchecking any checked by mistake, the user may choose to compose a message to the checked contacts (or return to a previous “Write” window if the address book was launched from a “Write” window) by selecting the “Write” button 525. Upon selecting the “Write” button 525, a “Write” window 300 will appear, enabling a user to compose a message to the e-mail addresses associated with the checked contact designations 510. If there is a contact that the user wishes to select but does not appear in the address book representation 500, the user can select the “New Contact” button 530 to add a new contact to the address book. After selecting the “New Contact” button 530, the user will be able to enter new contact information into an “Add New Contact” window. The user can also create a new e-mail list including the checked contacts by selecting the “New E-mail List” button 535. A “New E-mail List” window can then appear with the checked contact designations 510 being pre-populated by the e-mail client, and will enable the user to name the new e-mail list. The user can choose to delete a contact and its contact designation 510 by highlighting the contact designation 510 and selecting the “Delete” button 540. The user can edit the detailed information associated with a contact by highlighting the contact designation 510 and selecting the “Edit” button 545. The “Edit” button 545 will produce an “Edit Contact” window which enables the user to edit the various fields associated with the contact. Editing the contact can also be done selecting the “Details” button 520 associated with one of the contacts from the address book. Here the user can view the contact information and choose to edit the contact information for the selected contact. Finally, the user can close the address book window 500 by choosing the “Cancel” button 550.

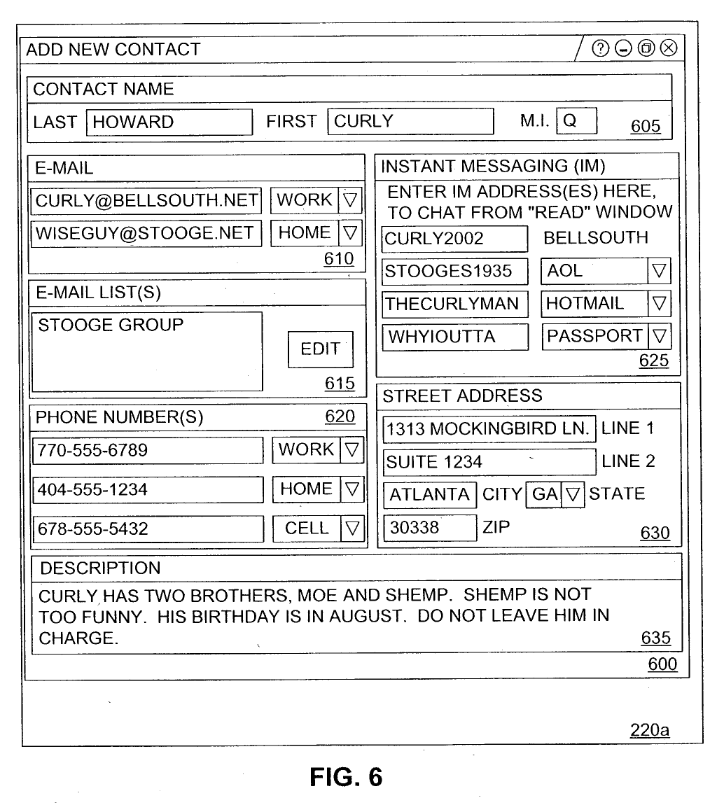

Referring now to FIG. 6, shown is a sample screen shot of an embodiment, among others, of an “Add New Contact” window 600 that will appear upon the user selecting the “New Contact” button 530 of FIG. 5. The user can also access this window by selecting one of the contact representations listed in FIG. 5. This window will enable the user to enter a contact into the e-mail-client. Further, a similar window can appear when the user wishes to edit the information associated with a contact. In the “Add New Contact” window 600, the user can enter the contact designation 605 and e-mail address(es) 610 into the system. Moreover, this window can keep track of which mailing list(s) 615 the contact belongs to. One skilled in the art will recognize that the “Add New Contact” window 600 can be configured to collect a plethora of information for the user and store it for later retrieval. Among the fields that may be included in this plethora of information collected are: telephone number(s) 620, instant messaging (IM) address(es) and systems 625, a street address 630, and a description of the contact 635. One skilled in the art will recognize that other information can also be collected, along with any combination of any of the above fields, and that each of these are intended to be included within the scope of the present invention.

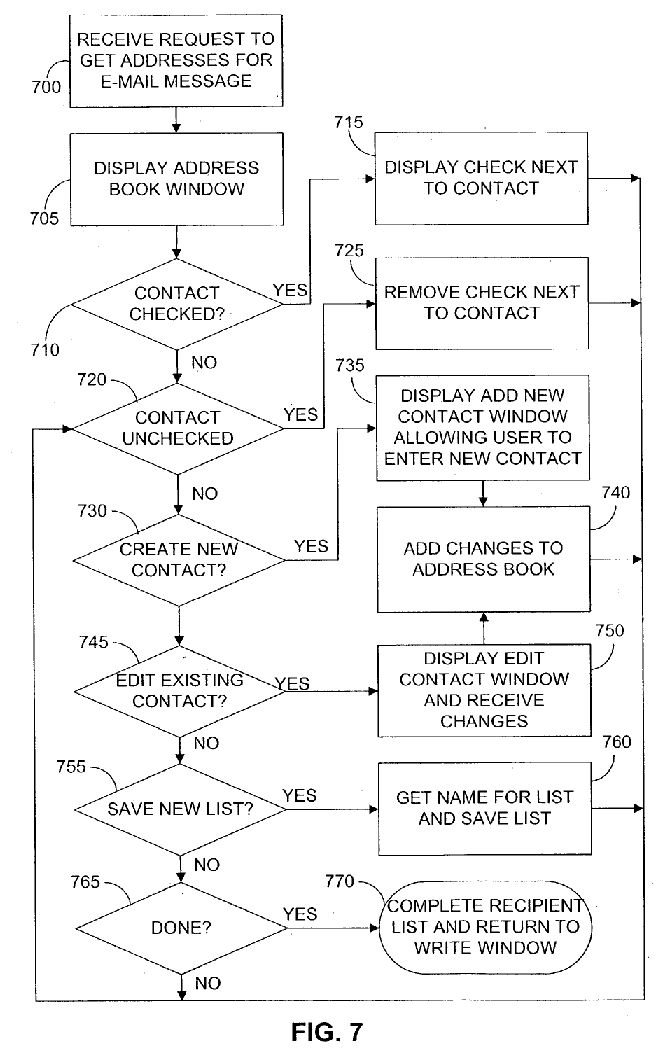

Referring now to FIG. 7, shown a flowchart of one embodiment, among others, illustrating a method of adding new addressees and contact information to an address book and recipient list. In step 700, the e-mail client receives a request from the user to get addresses for an e-mail message being composed. Typically, the request is created when the user selects one of the “Get Address” buttons 420a, 420b in the “Write” window 400. In step 705, the e-mail client displays an “Address Book” window 500. The address book window 500, as mentioned above, includes all of the contacts entered into the system. The window 500 will include a list of addressees 510, and it will enable the user to add addressees/contacts to the recipient list by checking a checkbox next to the addressee 510.

In step 710, the e-mail client checks to see if the user has checked an addressee 510 for the recipient list. If the user has chosen to add an addressee 500 to the recipient list, in step 715, the e-mail client will display a check next to the contact in the address book window 500. The user can also remove an addressee from the recipient list by unchecking a contact, so in step 720, the e-mail client checks for a request to uncheck an addressee 510. If a request to uncheck an addressee 510 is received, in step 725, the e-mail client removes the check from the addressee in the address book window 500.

In step 730, the e-mail client checks to see if a request to add a new contact to the address book has been received. If a request to create a new contact has been received, in step 735, the e-mail client displays a new contact window to enable the user to enter information for a new contact. Upon the entry of the new contact, the e-mail client adds the new contact to the address book in step 740.

In step 745, the e-mail client checks for a request to edit an existing contact. If a request to edit an existing contact has been received, the e-mail client opens and edit contact window with all of the existing information filled into the fields. The edit contact window then enables the user to change the fields at his/her pleasure in step 750, and add changes to address book at step 740.

In step 755, the e-mail client checks for a request to save the current list as a new mailing list. If the user requests to save the list as a new mailing list, in step 760, the e-mail client can prompt the user to enter a name for the new mailing list and save the new mailing list. In step 765, the e-mail client checks for a finish recipient list from the user. If a finish recipient list request is received, the e-mail client enters all e-mail addresses for the checked contacts into the recipient list for the e-mail message in step 770. If there is no request to finish the recipient list, the process starts back at step 710. In addition, each of steps 715, 725, 740, 760 restart the e-mail client at step 710.

Process and function descriptions and blocks in flow charts can be understood as representing, in some embodiments, modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention. In addition, such functional elements can be implemented as logic embodied in hardware, software, firmware, or a combination thereof, among others. In some embodiments involving software implementations, such software comprises an ordered listing of executable instructions for implementing logical functions and can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a computer-readable medium can be any means that can contain, store, communicate, propagate, or transport the software for use by or in connection with the instruction execution system, apparatus, or device.

In some contexts, references to contacts or users are understood to include references to e-mail addresses of such users, as would be understood to one skilled in the art. Furthermore, it should be emphasized that the above-described preferred embodiments of the present invention are merely possible examples of implementations set forth for a clear understanding of the principles of the invention. Many variations and modifications may be made to the above-described preferred embodiment(s) of the invention without departing substantially from the principles of the invention. All such modifications and variations are intended to be included herein within the scope of this disclosure and the present invention and protected by the following claims.

What is claimed is:

1. An e-mail client, comprising:
a mailbox representation of a mailbox operable to enable a user to review summary information regarding received messages; and
an address book representation of an address book operable directly from the mailbox representation to enable the user to select recipients for an outgoing message, and being further operable to enable the user to enter a new addressee and addressee contact information comprising a new contact directly into the address book.

2. The e-mail client of claim 1, further comprising:
an add new contact window operable to enable the user to enter new contact information into the address book along with a plurality of personal information associated with the new contact.

3. The e-mail client of claim 1, wherein the address book representation is further operable to enable the user to view detailed information about an existing contact.

4. The e-mail client of claim 3, wherein the address book representation is operable to enable the user to edit detailed information about an existing contact.

5. The e-mail client of claim 1, wherein the address book representation is further operable to enable the user to create a mailing list representation of a mailing list.

6. The e-mail client of claim 5, wherein the mailing list representation is created by enabling the user to select a plurality of contact representations using checkboxes and to save the mailing list representation by electing to save a mailing list comprising selected contacts.

7. The e-mail client of claim 1, further comprising:
a write e-mail window enabling the user to compose the outgoing message.

8. The e-mail client of claim 7, wherein the user can select to go to the address book representation from the write e-mail window.

9. The e-mail client of claim 1, wherein new contact information further comprises detailed information regarding each a new contact.

10. The e-mail client of claim 1, wherein the address book representation further includes a jump-to feature operable to enable the user to go directly to a desired contact.

11. A method of adding contacts to a recipient list, comprising:
displaying an address book representation of an address book to a user, the address book representation comprising a list of contacts included in the address book;
enabling the user to select a plurality of contacts from the address book representation; and
creating a recipient list comprising the plurality of selected contacts upon completion of selection by the user.

12. The method of claim 11, further comprising:
enabling the user to save the recipient list for later user by providing a name representation for the recipient list.

13. The method of claim 11, further comprising:
enabling the user to view a list of detailed information associated with a selected contact.

14. The method of claim 11, further comprising:
enabling the user to edit a list of detailed information associated with a selected contact.

15. The method of claim 11, further comprising:
enabling the user to add a new contact from the address book, including a list of detailed information associated with the new contact.

16. A computer readable medium having a program to provide an address book comprising a plurality of contacts, the program comprising the steps of:
displaying an address book representation of an address book to a user, the address book representation comprising a list of contacts entered into the address book;
enabling the user to select a plurality of contacts from the address book; and
creating a recipient list comprising the plurality of selected contacts upon completion of selection by the user.

17. The program of claim 16, further comprising:
enabling the user to save the recipient list for later user by providing a name representation for the recipient list.

18. The program of claim 16, further comprising:
enabling the user to view a list of detailed information associated with a selected contact.

19. The program of claim 16, further comprising:
enabling the user to edit a list of detailed information associated with a selected contact.

20. The program of claim 16, further comprising:
enabling the user to add a new contact from the address book representation, including a list of detailed information associated with the new contact.
